(19) United States
(12) Patent Application Publication
(10) Pub. No.: US 2003/0034621 A1
(43) Pub. Date: Feb. 20, 2003

(54) Disposable luggage cart

(76) Inventor: David Harris Weissman, New York, NY (US)

Correspondence Address: PENNIE AND EDMONDS, 1155 AVENUE OF THE AMERICAS, NEW YORK, NY, 100362711

(21) Appl. No.: 10/017,665

(22) Filed: Dec. 14, 2001

Related U.S. Application Data
(63) Continuation-in-part of application No. 29/146,824, filed on Aug. 16, 2001, now Pat. No. D464487.

(51) Int. Cl. B62B 1/00

(52) U.S. Cl. 280/47.131

(57) ABSTRACT

The present invention relates generally to the field of luggage and cargo hand carts and more particularly to an inexpensive, disposable cart for transporting large, heavy, or bulky items. The present invention discloses a lightweight, easily and inexpensively manufactured, disposable cart. The cart may be manufactured from an inexpensive, lightweight material, such as plastic. The cart is comprised of a pair of load bearing surfaces in the form of a horizontal platform and a vertical backstop joined so that the faces of their surfaces are at approximately a right angle. A pair of wheel assemblies is located at the intersection of the bearing surfaces, one at each side of the platforms. Each wheel assembly preferably comprises a pair of wheels with a common axle. Adhesive strips may be located on the bearing surfaces to position and to attach the cart to the object to be transported while ropes or cables are wrapped around the entire assembly for additional security. The configuration of the cart allows it to be readily attached to a lower corner of any size object and then “tipped” back so that the cart, with the object attached to it, then sits only on the wheels. As such, the object to be transported can be easily moved and maneuvered by hand to a desired location. As the cart is preferably designed as a single use product, once the cart has served its function, it may be discarded, along with the container containing the object to be transported.

### FIELD OF THE INVENTION

The present invention relates generally to the field of luggage and cargo hand carts and more particularly to an inexpensive, disposable cart for transporting large, heavy, or bulky items.

### BACKGROUND OF THE INVENTION

The use of handcarts or “handtrucks” is well known. Generally, these carts consist of a large, heavy, steel frame, equipped with handles and wheels. These carts are useful for the hand transportation of bulky items but, as a consequence of their design, are not themselves easily transported or available when needed most. Oftentimes, a purchaser of goods may need a cart to bring purchased goods home, but does not have access to a cart. And although the retailer may have a handcart available, it is unlikely that the retailer would be willing to lend (or even rent) this cart to each and every consumer who might need one. A handcart or dolly may also be necessary when traveling. For instance, a traveler may arrive at an airport only to find that his luggage must be carried a great distance to the next gate or to ground transportation and thus he may have difficulty getting to his destination without assistance.

To deal with this problem, there have been attempts at manufacturing portable or collapsible carts, but these carts may still be somewhat heavy and cumbersome for carrying on one's person, and they still require that the cart be carried by the user (possibly for an extended period of time) to the point of use. In addition, these carts require that the user have the foresight to realize that a cart will be necessary. Thus, there is a need to provide a simple, inexpensive, and disposable lightweight cart that is readily available at the point of use so that bulky items may be easily transported by hand.

### SUMMARY OF THE INVENTION

Thus, the present invention discloses a lightweight, easily and inexpensively manufactured, disposable cart. These carts may be made available at airports, retail stores where large items are sold, or may even be incorporated directly into the boxes and containers that hold large, bulky items. As a separate unit, the cart may be attached to the outside of a container or, if no container is utilized, the cart may be attached directly to the object to be transported.

The cart may be manufactured from an inexpensive, lightweight material, such as plastic, that has the strength to provide the required structural capacity. In the preferred embodiment the cart is comprised of a pair of load bearing surfaces in the form of a horizontal platform and a vertical backstop. Preferably, these two components are joined so that the faces of their surfaces are at approximately a right angle. However, the angle at which the two surfaces are joined may conceivably vary based upon the intended use for the cart. A pair of wheel assemblies is located at the intersection of the bearing surfaces, one at each side of the platforms. Each wheel assembly preferably comprises a pair of wheels with a common axle.

Adhesive strips may be located on the bearing surfaces to position and to attach the cart to the object to be transported while ropes or cables are wrapped around the entire assembly for additional security. The ropes also may serve as handles with which the user can maneuver, push, or pull the cart. Alternatively, a disposable handle may be attached either to the ropes or directly on the object to be transported.

The configuration of the cart allows it to be readily attached to a lower corner of any size object and then “tipped” back so that the cart, with the object attached to it, then sits only on the wheels. As such, the object to be transported can be easily moved and maneuvered by hand to a desired location. As an alternative, two carts can be placed at opposite sides of an object to be transported for use as a dolly. In this configuration, one of the carts may have its wheels mounted on swivels to permit steering.

As the cart is preferably designed as a single use product, once the cart has served its function, it may be discarded, along with the container containing the object to be transported. If no outer container was utilized, the cart may be removed from the object to be transported and disposed. Although typical handcarts and handtrucks may theoretically be disposed of after a single use, the expense of doing so would be prohibitive and would create great waste. The present invention, however, allows the use of inexpensive materials to construct an inexpensive cart, purposely designed to be disposed of after a single use.

### BRIEF DESCRIPTION OF THE DRAWINGS

FIG. 1 is a perspective view of a disposable luggage cart.

FIG. 2 is a front view of a disposable luggage cart.

FIG. 3 is a rear view of a disposable luggage cart.

FIG. 4 is a left side view of a disposable luggage cart.

FIG. 5 is a right side view of a disposable luggage cart.

FIG. 6 is a top view of a disposable luggage cart.

FIG. 7 is an underside view of a luggage cart.

### DESCRIPTION OF THE PREFERRED EMBODIMENTS

The cart 10 of the present invention may be manufactured from an inexpensive, lightweight material, such as plastic. It is conceivable that other materials such as corrugated cardboard, wood, styrofoam, recycled paper products, or aluminum, for instance, could also be used without departing from the principles of the disclosed invention. The major portions of the cart may be manufactured as a single piece molding or may be assembled from individual components.

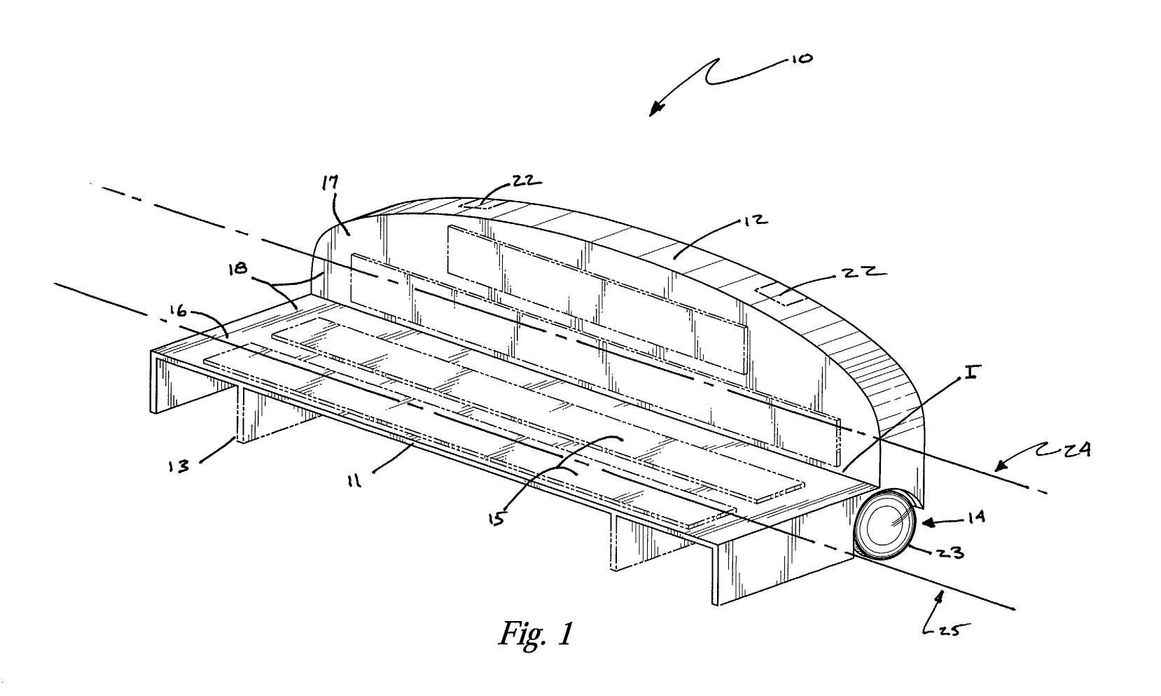

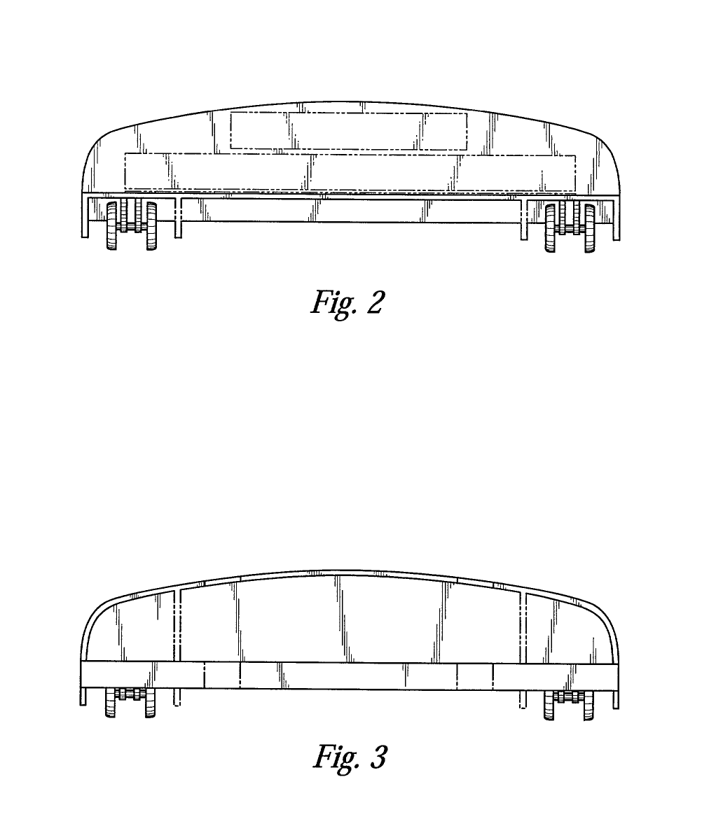

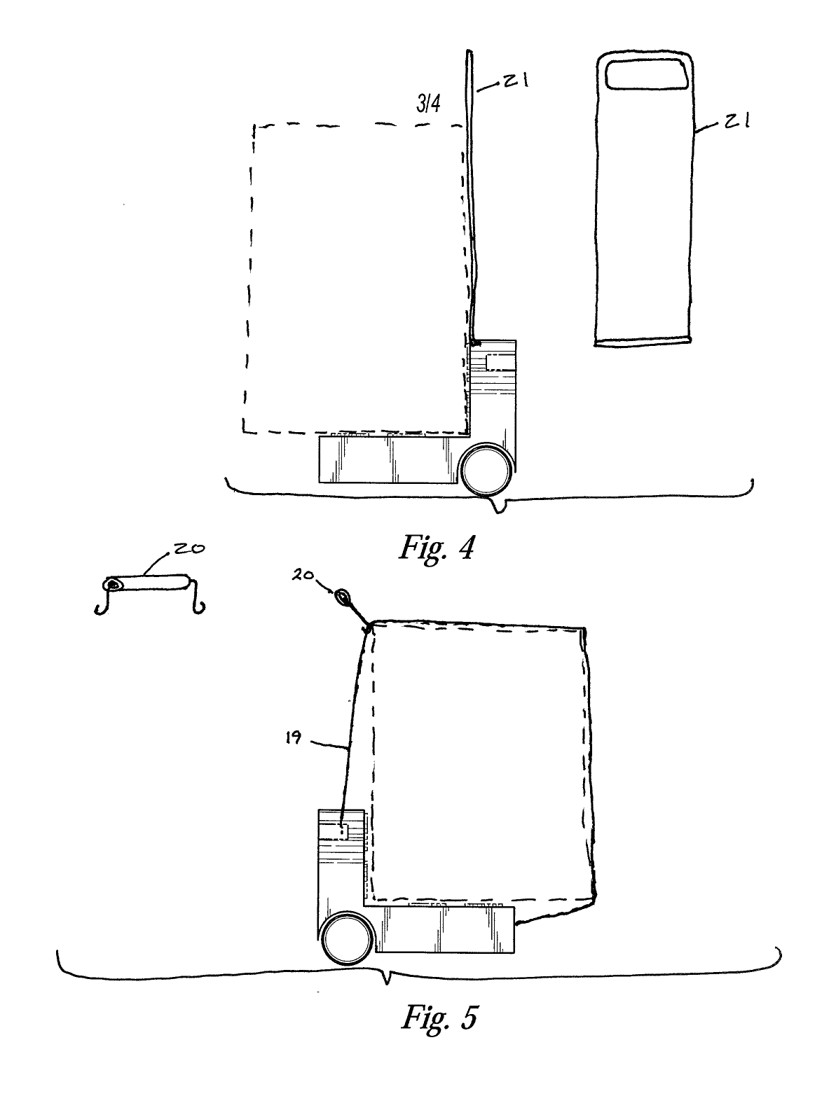

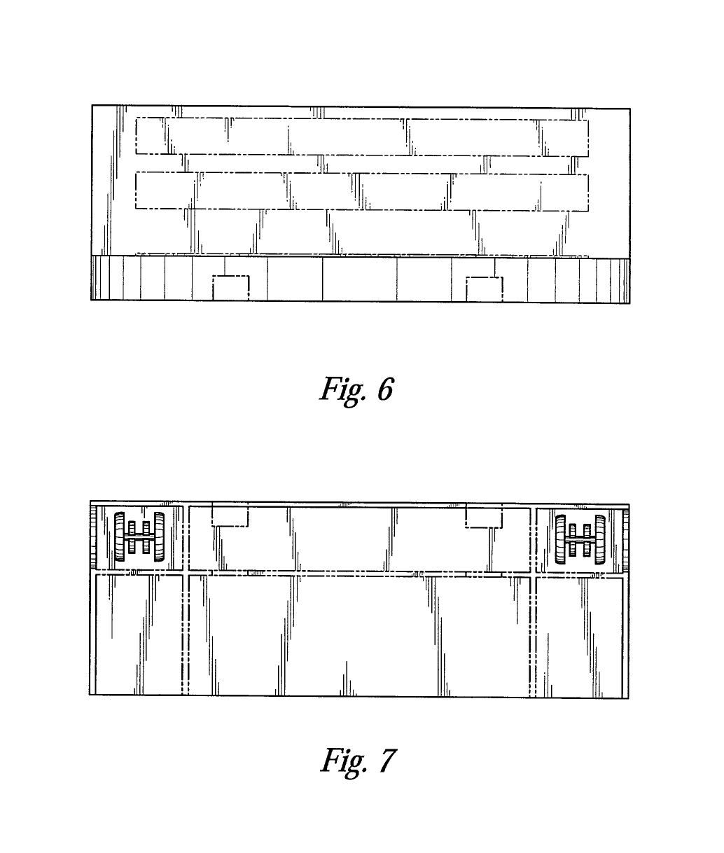

FIG. 1 shows the major components of the disposable cart. A horizontal platform 11 with horizontal face 16 and a vertical backstop 12 with vertical face 17 form the load bearing surfaces 18 of the cart. The horizontal platform 11 and vertical backstop 12 are preferably rigidly connected to each other at an intersection point I. The longitudinal axis 24 of vertical backstop 12 preferably are parallel to longitudinal axis 25 of horizontal platform 11. Horizontal face 16 and vertical backstop 12 are positioned at an approximate right angle to each other. However, other configurations may be utilized as required for a particular use. For instance, the horizontal platform 11 and the vertical backstop 12 may be connected together at an angle greater than 90° to facilitate attachment of the cart to a heavy, soft sided container such as is used to transport dog food or concrete mix, for example.

Horizontal platform 11 and vertical backstop 12 are made from a lightweight, stiff material and utilize structural stiffeners 13 underneath platform 11 and backstop 12 to reinforce the cart. Structural stiffeners 13 can be thin sections of material placed perpendicular to the surface to be reinforced, as shown in the figures. The structural stiffeners may also take the form of built up or thickened sections of material, sufficiently sized to provide the appropriate structural capacity. The placement of the stiffeners may be as shown in the figures or in other locations as required or desired. Also, any number of stiffeners may be used, preferably to achieve the desired effect. The use of these structural stiffeners 13 enables the components of cart 10 to be constructed of thin, lightweight materials that otherwise might not be strong enough to support the envisioned loads. As a result, the cost to produce each cart is kept very low, thereby making it economical to dispose of the cart after a single use. In addition, the lack of durability of these thin, lightweight materials is not a concern as cart 10 will most likely not be used more than once. Therefore, by dispensing with the necessity of using durable materials, the cost of manufacturing cart 10 is reduced even further. In contrast, typical handcarts and handtrucks are designed to be durable to ensure adequate strength over an extended lifetime and as a result, more costly materials and construction are required for these handcarts and bandtrucks. The result is that disposal of a typical handcart after a single use is extremely uneconomical, creates great waste, and is not intended by design.

Wheel assemblies 14 are located on the lower surface of horizontal platform 11, preferably generally below the intersection of vertical backstop 12 and horizontal platform 11. The placement of wheel assemblies 14 in this location allows attachment of wheels 23 without the need for the additional, and heavier, support structure that would be necessary if the wheels 23 were placed behind cart 10, as is common in many typical handtrucks. This reduction in materials also helps to minimize cost. A wheel assembly 14 is preferably located at each side of cart 10 for stability. Each wheel assembly 14 may consist of one or more wheels 23. On the preferred embodiment, the wheel assemblies 14 are directionally fixed and wheels 23 are aligned with the sides of the cart, as exemplified in FIG. 1. In this configuration, cart 10 can be used by tilting cart 10 and the object to be transported backwards onto wheels 23 and then moving the object. In an alternate embodiment, wheel assemblies 14 can swivel 360° for use as a steering mechanism. In this configuration, one cart utilizing swiveling wheel assemblies can be attached to one end of an object while a standard cart without swiveling wheels can be attached to the other end. The object can then be rolled and steered without tilting the object backwards. It will be appreciated that reference herein to “object” is for the sake of simplicity and not limitation, such term encompassing any and all objects including containers containing objects to be transported.

Adhesive strips 15 may be applied to horizontal face 16 and/or vertical face 17 of load bearing surfaces 18. These strips align and hold cart 10 in place against the object to be transported. The user need only remove the protective backing of the adhesive strip and then attach cart 10 onto a lower edge of the object. Adhesive strips 15 can be formed from common double-sided tape applied to horizontal face 16 and vertical face 17. Alternatively, glue, tacks, nails, or another similar attachment method could also be used to secure cart 10 to the object to be transported.

Ropes 19 or cables (not shown) may be positioned around the loaded cart assembly to further secure the object to cart 10. The ropes 19 additionally can serve as gripping points for maneuvering or moving cart 10 or as an attachment point for a handle 20. Rope positioning notches 22 may be provided on vertical backstop 12 and the lower surface of horizontal platform 11 to position ropes 19 and to restrain them from slipping off of cart 10.

A disposable handle 20 can be provided to ease maneuvering of cart 10. Handle 20 may be typical of the type made available in department stores, such as a cardboard tube with securing wire running through the tube. The securing wire of handle 20 hooks onto securing ropes 19 or can be attached to the object using adhesives or adhesive tape. An alternative version of the handle 21 has hooks which attach to cart 10 and an upwardly extending, flat, plastic handle. The flat portion is secured to the object using adhesive tape and the gripping portion of the handle extends upwards above the object.

While a disposable luggage cart formed in accordance with the principles of the present invention is particularly shown and described herein with reference to particular embodiments, it is to be understood that the invention may be used with many additions, substitutions, or modifications of form, structure, arrangement, proportions, materials, and components and otherwise, used in the practice of the invention, which are particularly adapted to specific environments and operative requirements without departing from the spirit and scope of the present invention. For instance, various other materials and various different configurations of the platform and backstop may be used. Moreover, although the wheel assemblies are shown as including a pair of wheels, different configurations and differently shaped wheels, such as substantially spherical, may be used. The presently disclosed embodiments are therefore to be considered in all respects as illustrative and not restrictive, the scope of the invention being indicated by the appended claims, and not limited to the foregoing description.

What is claimed is:

1. A lightweight, disposable cart comprising:
a platform with a longitudinal axis, a face, and an underside;
a backstop with a longitudinal axis, a face, and a backside, said backstop being coupled to said platform at an intersection point, and said backstop longitudinal axis parallel to said platform longitudinal axis;
structural stiffeners formed on at least one of said platform underside and said backstop; and
a wheel assembly connected to said platform, directly below said intersection point of said platform and said backstop;
wherein said platform, said backstop, and said structural stiffeners are formed from lightweight material.

2. The lightweight, disposable cart of claim 1, wherein said structural stiffeners are formed on said platform underside.

3. The lightweight, disposable cart of claim 1, wherein said structural stiffeners are formed on said backstop backside.

4. The lightweight, disposable cart of claim 1, additionally comprising adhesive strips mounted on at least one of said platform face and said backstop face.

5. The lightweight, disposable cart of claim 4, wherein said adhesive strips are mounted on both of said platform face and said backstop face.

6. The lightweight, disposable cart of claim 4, additionally comprising securing ropes extending from said platform and said backstop.

7. The lightweight, disposable cart of claim 6, additionally comprising a plurality of rope positioning notches on said backstop and said platform.

8. The lightweight, disposable cart of claim 1, additionally comprising a swivel attached to said platform underside;
wherein said wheel assembly is mounted on said swivel for rotational movement about a vertical axis.

9. The light weight, disposable cart of claim 8, additionally comprising a plurality of rope positioning notches on said backstop and said platform.

10. The lightweight, disposable cart of claim 6, additionally comprising a handle extending from said backstop.

11. A lightweight, disposable cart comprising:
a platform formed from a thin, lightweight material and having a longitudinal axis, a face, and an underside;
a backstop formed from a thin, lightweight material and having a longitudinal axis, a face, and a backside, said backstop being coupled to said platform along an intersection point with said backstop longitudinal axis parallel to said platform longitudinal axis;
structural stiffeners formed on said cart; and
a wheel assembly connected to said platform;
wherein said thin, lightweight material lacks sufficient strength to support a load placed upon said cart without the use of said structural stiffeners.

12. The lightweight, disposable cart of claim 11, wherein said structural stiffeners are formed on said platform.

13. The lightweight, disposable cart of claim 12, wherein said structural stiffeners are also formed on said backstop.

14. The lightweight, disposable cart of claim 11, wherein said structural stiffeners are formed on said backstop.

15. The lightweight, disposable cart of claim 11, wherein said wheel assembly is located directly below said intersection point of said platform and said backstop.

16. The lightweight, disposable cart of claim 1 wherein said backstop is fixedly connected to said platform.
